(19) United States
(12) Patent Application Publication
(10) Pub. No.: US 2018/0025424 A1
(43) Pub. Date: Jan. 25, 2018

(54) SYSTEM AND METHOD FOR ELECTRONIC DATA SUBMISSION PROCESSING

(71) Applicant: TSX INC., Toronto (CA)

(72) Inventors: Timothy BABCOCK, Toronto (CA); Van LUU, Toronto (CA); Linda SHARDLOW, Vancouver (CA); Pierre TRAC, Toronto (CA)

(21) Appl. No.: 15/549,558

(22) PCT Filed: Feb. 17, 2015
(86) PCT No.: PCT/CA2015/000089

§ 371 Date: Aug. 8, 2017

(51) Int. Cl. G06Q 40/04; G06F 17/30; G06F 11/07

(52) U.S. Cl. CPC G06Q 40/04; G06F 11/0709; G06F 17/30002; G06F 17/30368

(57) ABSTRACT

Electronic submissions, such as those for capital markets, are processed by evaluating the data contained in the electronic submissions against failure conditions. The failure conditions may include a static failure condition and a scalar failure condition. The static failure condition identifies a data element that is to be present or absent for the static failure condition to be met. The scalar failure condition identifies data that is to conform to an inequation for the scalar failure condition to be met. The electronic submission can be approved upon completion of the evaluation when all failure conditions are not met. The electronic submission can be thus approved with no human analyst intervention or review needed. When one or more failure condition is met, the electronic submission requires further analysis. Specific advantageous failure conditions are discussed. Feedback can be employed to increase approvals that trigger no failure conditions.

### FIELD

This disclosure relates to electronic data systems.

### BACKGROUND

Review and approval of complex electronic data submissions is a complicated and time-consuming task. Human judgement is often relied upon for each submission. Aside from increased time to exercise judgement, communications may be required between a reviewer and a data submitter to clarify or understand the nature of the data. Such communications often amount to increased network traffic, the use of storage resources, and additional staff resources, all of which may be better spent. These problems become more acute as the volume and rate of submissions increases.

In addition, the use of human judgement, at least when objective criteria are concerned, can lead to inefficiencies and potentially to human bias. This may occur in systems used in the financial industry, where a human analyst is tasked to approve a particular submission for a capital market transaction or event. Humans make mistakes and may inadvertently delay submissions when no problem actually exists. Further, even with extensive training, bias may creep in.

To date, no systems have been developed to solve these problems in an efficient and practical way.

### SUMMARY

According to one aspect of the present invention, a method of updating a database with data pertaining to capital market transactions or events includes a server receiving via a network an electronic submission containing data for a capital market transaction or event requiring one or more of review and approval by a market entity. The data is according to a predetermined structure. The server stores the data in a database. The method further includes evaluating the data contained in the electronic submission against a plurality of failure conditions, the plurality of failure conditions including at least one scalar failure condition. The at least one scalar failure condition identifies data that is to conform to an inequation for the scalar failure condition to be met. The method further includes processing the electronic submission upon completion of the evaluation when each failure condition of the plurality of failure conditions is not met, and upon successfully processing the electronic submission, updating the database to indicate that the submission has been successfully processed. The method further includes when one or more failure conditions of the plurality of failure conditions is met, updating the database to indicate that the data requires further analysis.

The method can further include updating the at least one scalar failure condition based on one or more of a rate of successful processing of electronic submissions based on evaluation of the plurality of failure conditions and outcomes of electronic submissions based on the further analysis, so as to control a rate of submissions that meet none of the failure conditions and control a rate of submissions requiring further analysis.

The at least one scalar failure condition can be updated based on a rate of successful approval of electronic submissions, so as to increase a rate of submissions that meet none of the failure conditions and decrease a rate of submissions requiring further analysis.

The plurality of failure conditions can further include at least one static failure condition, the at least one static failure condition identifying a data element of the data that is to be present or absent for the static failure condition to be met.

The method can further include updating the at least one static failure condition based on one or more of a rate of successful processing for electronic submissions based on evaluation of the plurality of failure conditions and outcomes of electronic submissions based on the further analysis, so as to control a rate of submissions that meet none of the failure conditions and control a rate of submissions requiring further analysis.

The at least one static failure condition can be updated based on a rate of successful approval of electronic submissions, so as to increase a rate of submissions that meet none of the failure conditions and decrease a rate of submissions requiring further analysis.

The method can further include evaluating the inequation of the at least one scalar failure condition by comparing the data to a configurable value.

The method can further include the server receiving data for the at least one scalar failure condition from a remote server via the network, the data for the at least one scalar failure condition being used to obtain a calculated value, and evaluating the inequation of the at least one scalar failure condition by comparing the calculated value to a configurable value.

The method can further include the server transmitting via the network an electronic alert to an analyst terminal upon updating the database to indicate that the data requires further analysis.

The method can further include sending a notification indicative of the one or more of review and approval to a submitter terminal at which the electronic submission originates.

The method can further include cross-referencing the data of the electronic submission with data present in at least one other existing data source remote from the database to validate the electronic submission.

The method can further include cross-referencing the data of the electronic submission with data present in at least one other existing data source remote from the database as part of evaluating the data contained in the electronic submission against the plurality of failure conditions.

The method can further include generating a review package including data from the electronic submission, any met failure conditions, and associated data obtained from at least one other existing data source remote from the database, and presenting the review package to an analyst terminal for the further review.

The method can further include the server operating as a trusted identity provider for claims-based authentication of a submitter terminal at which the electronic submission originates.

According to another aspect of the present invention, a system for processing data pertaining to capital market transactions or events includes a network interface configured to receive data of an electronic submission from a submitter terminal over a network. The electronic submission pertains to a capital market transaction or event requiring one or more of review and approval by a market entity. The system further includes a validation engine coupled to the network interface, the validation engine configured to issue a prompt to the submitter terminal for data that fails validation. The system further includes a database for storing the data of the electronic submission and a review and approval engine coupled to the network interface. The review and approval engine is configured to evaluate the data contained in the electronic submission against a plurality of failure conditions, the plurality of failure conditions including at least one scalar failure condition. The at least one scalar failure condition identifies data that is to conform to an inequation for the scalar failure condition to be met. The review and approval engine is further configured to process the electronic submission upon completion of the evaluation when each failure condition of the plurality of failure conditions is not met. The review and approval engine is further configured to update the database to indicate that the submission has been successfully processed upon successfully processing the electronic submission. The review and approval engine is further configured to update the database to indicate that the data requires further analysis when one or more failure conditions of the plurality of failure conditions is met.

The review and approval engine can be further configured to update the at least one scalar failure condition based on one or more of a rate of successful processing of electronic submissions based on evaluation of the plurality of failure conditions and outcomes of electronic submissions based on the further analysis, so as to control a rate of submissions that meet none of the failure conditions and control a rate of submissions requiring further analysis.

The at least one scalar failure condition can be updated based on a rate of successful approval of electronic submissions, so as to increase a rate of submissions that meet none of the failure conditions and decrease a rate of submissions requiring further analysis.

The plurality of failure conditions can further include at least one static failure condition, the at least one static failure condition identifying a data element of the data that is to be present or absent for the static failure condition to be met.

The review and approval engine can be further configured to update the at least one static failure condition based on one or more of a rate of successful processing for electronic submissions based on evaluation of the plurality of failure conditions and outcomes of electronic submissions based on the further analysis, so as to control a rate of submissions that meet none of the failure conditions and control a rate of submissions requiring further analysis.

The at least one static failure condition can be updated based on a rate of successful approval of electronic submissions, so as to increase a rate of submissions that meet none of the failure conditions and decrease a rate of submissions requiring further analysis.

The review and approval engine can be further configured to evaluate the inequation of the at least one scalar failure condition by comparing the data to a configurable value.

The network interface can be further configured to receive data for the at least one scalar failure condition from a remote server via the network, the data for the at least one scalar failure condition being used to obtain a calculated value. The review and approval engine can be further configured to evaluate the inequation of the at least one scalar failure condition by comparing the calculated value to a configurable value.

The system can further include a messaging engine configured to send an electronic alert to an analyst terminal upon update of the database to indicate that the data requires further analysis.

The system can further include a messaging engine configured to send a notification indicative of the one or more of review and approval to a submitter terminal at which the electronic submission originates.

The review and approval engine can be further configured to cross-reference the data of the electronic submission with data present in at least one other existing data source remote from the database to validate the electronic submission.

The review and approval engine can be further configured to cross-reference the data of the electronic submission with data present in at least one other existing data source remote from the database as part of evaluating the data contained in the electronic submission against the plurality of failure conditions.

The review and approval engine can be further configured to generate a review package including data from the electronic submission, any met failure conditions, and associated data obtained from at least one other existing data source remote from the database, and to present the review package to an analyst terminal for the further review.

The system can further include accounts logic configured to operate a trusted identity provider for claims-based authentication of a submitter terminal at which the electronic submission originates.

The data of the electronic submission can be representative of a private placement. The at least one static failure condition can include an indication of a control person. The at least one static failure condition can include an indication of a predetermined specific type of security. The at least one static failure condition can include the presence of an additional open electronic submission associated with an entity submitting the electronic submission. The at least one static failure condition can include the presence of a data element in a compliance and disclosure database. The at least one scalar failure condition can include an indication of an excessive placement amount to one or more insiders. The at least one scalar failure condition can include an indication of an excessive placement amount to any combination of one or more insiders, one or more large holders, and one or more registered market professionals. The at least one scalar failure condition can include an indication of an excessive placement amount relative to issued and outstanding securities. The at least one scalar failure condition can include an indication of a price spike.

### BRIEF DESCRIPTION OF THE DRAWINGS

The drawings illustrate, by way of example only, embodiments of the present disclosure.

FIG. 1 is a diagram of a system according to the present invention.

FIG. 2 is a diagram of a submissions server and submissions database.

FIG. 3 is a flowchart of a submission validation process.

FIG. 4 is a flowchart of a submission approval process that evaluates static and scalar conditions.

FIG. 5 is a schematic diagram showing an example submission data structure.

FIG. 6 is a state diagram for a submission.

FIG. 7 is a diagram showing examples of static and scalar conditions and their relationships.

FIG. 8 is a diagram showing a price spike determination.

FIG. 9 is a diagram of accounts logic and claims and security relationships.

FIG. 10 is a flowchart of a submission review process that evaluates static and scalar conditions.

### DETAILED DESCRIPTION

The techniques described herein can be applied to systems and processes in a wide-variety of industries. The financial industry is an illustrative example of where these techniques may be applied. Specifically, review and/or approval of capital markets submissions made by, or on behalf of, issuers or other market participants, which prior to this invention have mainly been reviewed and approved by human beings, can be facilitated by way of the techniques discussed herein. Private placements are an example of capital market submissions. The handling of private placement submissions is one illustrative example of an application for this technology. Private placement is, however, a salient example of where past attempts have not been able to address the numerous technical challenges.

While private placements are the basis for the examples discussed herein, it is contemplated that the inventive techniques can be applied to other capital market submissions, such as submissions regarding any capital market transaction or event (e.g., issuance of securities such as those for equity or debt, completion of mergers and acquisitions, onboarding of issuers or other market participants, and initial public offerings or IPOs) requiring review and/or approval by a market entity, such as a marketplace, transfer agent, exchange, market participant, regulatory body, clearing service, depository service, or the like. Such other capital market submissions may pertain to various classes of financial instrument or interest, such as equity, debt, derivatives, and other securities.

A private placement occurs when an issuer issues securities from treasury in exchange for cash. The issued securities may be shares, units, convertible securities, or other kinds of financial instrument or interest. Private placements rely on exemptions from prospectus and registration requirements often required by securities laws.

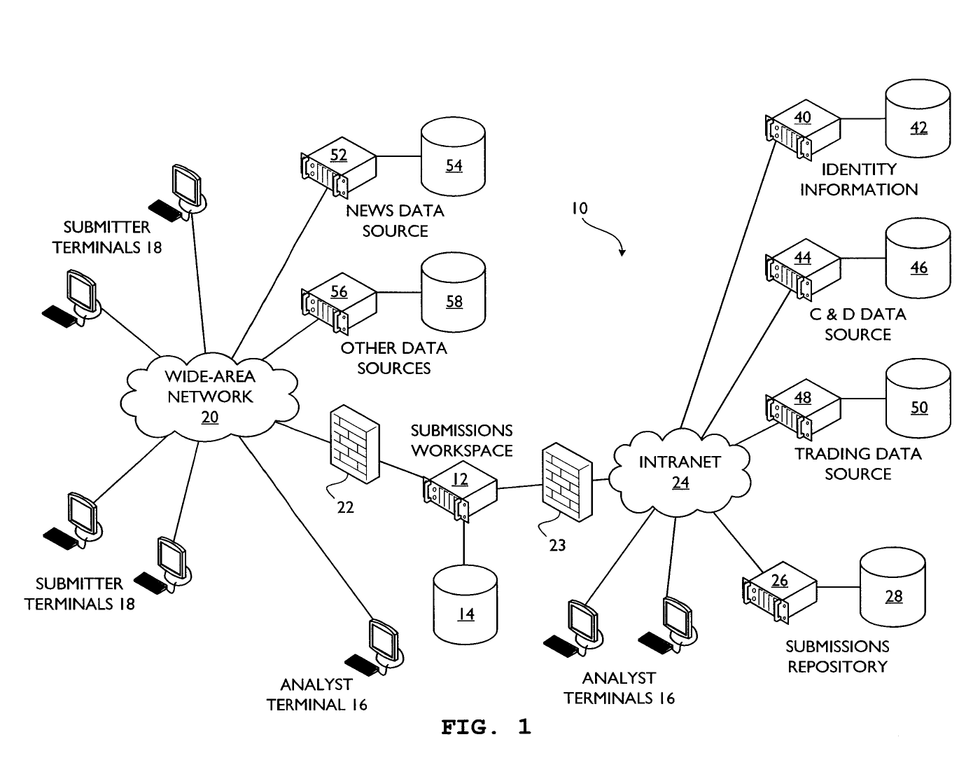

FIG. 1 shows a system 10 according to the present invention. The system 10 includes a submissions workspace having a submissions server 12 and a submissions database 14. The submissions workspace processes incoming requests for review and/or approval of private placements and processes reviews and/or approvals for such private placements based on the evaluation of validation conditions, static failure conditions, and scalar failure conditions that are specifically configured to reduce demand and reliance on human review and judgement for individual submissions. Analyst terminals 16 support the review and/or approval process by allowing human judgement for review and approval of exceptional submissions and by updating failure conditions in a feedback loop to further reduce dependence on human judgement for individual submissions. The submissions workspace, hence, quantizes human judgement and provides for automatic approval of private placements and may advantageously reduce the time and resources required to approve individual submissions, allow processing of high volumes of submissions efficiently, and reduce or nullify human bias in individual approval decisions.

Regarding review and/or approval of submissions, review can be performed and the output from such review can be stored for future reference and/or future action, which may include approval. Review may be performed by one entity using any of the systems and methods discussed herein, whereas approval may be performed by another entity based on such review. Approval of a submission need not be performed immediately upon receiving the submission. Each of review and approval and their combination can be referred to as processing a submission, where successful processing results in completion of review, approval, or both.

The submissions server 12 is configured to receive submissions from submitter terminals 18. Submissions contain data concerning private placements. The submitter terminals 18 are operated by individuals representing issuers or other market participants (e.g., corporations or their representatives) that wish to submit for review and/or approval private placements to a market entity (e.g., an exchange) using the submissions workspace. The submissions server 12 is connected to a wide-area network 20, such as the Internet, via a firewall 22 or other security infrastructure. Submitter terminals 18 access the submissions server 12 via the wide-area network 20.

The analyst terminals 16 are connected to the submissions server 12 via a network 24, such as an intranet that is within the domain of the submission system. The submissions server 12 is connected to the network 24 via a firewall 23. Analyst terminals 16 may also access the submissions server 12 via the wide-area network 20.

Final submissions are transferred from the submissions workspace to a submissions repository connected to the intranet 24. The submissions repository includes a repository server 26 and repository database 28. The submissions repository may be a legacy system that also stores historic submissions made without the benefit of the submissions workspace.

The submissions server 12 connects to a variety of external data sources when processing a submission. The submissions server 12 can reference data obtained from such data sources when validating a submission, when automatically approving a submission, and when presenting a submission for analyst approval. The submissions server 12 cross-referencing inputted data with one or more other data sources can advantageously reduce the chance of a single point of failure and further help ensure that no single data source leads to an approval or refusal decision.

Data from other sources may be in structured or unstructured form. Examples of structured data include database records containing text and numerical values. Names and other potentially ambiguous information are normalized. Examples of unstructured data include scans of documents and database records containing free text.

At least one identity information source includes an identity information server 40 and identity information database 42. The identity information server 40 is connected to the intranet 24 and configured for access by the submissions workspace. The identity information database 42 stores information concerning individuals, such as names of individuals in association with corporations and other entities, holdings in association with individual names, and indications of role, employment, and personal and professional relationships with other parties. The identity information database 42 further stores the names, symbols, and other particulars of issuers. Dates of relevant statuses or events may also be stored. The identity information source can accordingly be used to identify relationships among insiders, large holders, registered market professionals, and their relatives. The identity information server 40 is configured to respond to queries identifying names of individuals and entities (e.g., corporations). It is contemplated that an identity information source may be accessible via the wide-area network 20 instead of, or in addition to, the intranet 24. It is further contemplated that several identity information sources are used and that each source may store data for specific kinds of identities.

At least one compliance and disclosure data source has a compliance and disclosure server 44 and a compliance and disclosure database 46. The compliance and disclosure server 44 is connected to the intranet 24 and configured for access by the submissions workspace. The compliance and disclosure database 46 stores information concerning compliance and disclosure for corporations, issuers, placees (e.g., receivers of securities), individuals, and other market participants. The compliance and disclosure server 44 is configured to respond to queries from the submissions workspace. It is contemplated that a compliance and disclosure data source may be accessible via the wide-area network 20 instead of, or in addition to, the intranet 24.

At least one trading data source includes a trading server 48 and a trading database 50. The trading server 48 is connected to the intranet 24 and configured for access by the submissions workspace. The trading database 50 stores trading price information for securities issued by issuers. The trading database 50 may also store trade volume and other trading information. The trading server 48 is configured to respond to queries from the submissions workspace. It is contemplated that a trading data source may be accessible via the wide-area network 20 instead of, or in addition to, the intranet 24.

At least one news data source has a news server 52 and a news database 54. The news server 52 is connected to the wide-area network 20 and configured for access by the submissions workspace. The news database 54 stores news data and, specifically, text of press releases or other public communications of corporations and other entities. The news server 52 is configured to provide the text of press releases in response to requests for such from any terminal, server, or other device connected to the wide-area network. Alternatively or additionally, the news server 52 is configured to respond to specific queries from the submissions workspace. It is contemplated that a news data source may be accessible via the intranet 24 instead of, or in addition to, the wide-area network 20.

At least one other data source includes a server 56 and a database 58. The server 56 may be connected to the wide-area network 20 and configured for access by the submissions workspace. It is contemplated that such a data source may be accessible via the intranet 24 instead of, or in addition to, the wide-area network 20.

The submitter and analyst terminals 18, 16 each include a processor, memory, a network interface, and a display and other user-interface components. The processor, memory, network interface, and display and user interface are electrically interconnected and can be physically contained within a housing or frame.

The processor of each of the submitter and analyst terminals 18, 16 is configured to execute instructions, which may originate from the memory or the network interface. The processor may be known as a central processing unit (CPU). The processor can include one or more sub-processors or processing cores.

The memory of each of the submitter and analyst terminals 18, 16 includes a non-transitory computer-readable medium that is configured to store programs and data. The memory can include one or more short-term or long-term storage devices, such as a solid-state memory chip (e.g., DRAM, ROM, non-volatile flash memory), a hard drive, an optical storage disc, and similar. The memory can include fixed components that are not physically removable from the terminal (e.g., fixed hard drives) as well as removable components (e.g., removable memory cards). The memory allows for random access, in that programs and data may be both read and written.

The network interface of each of the submitter and analyst terminals 18, 16 is configured to allow the terminal to communicate with servers and terminals across one or more networks. The network interface can include one or more of a wired and wireless network adaptor and well as a software or firmware driver for controlling such adaptor.

The display and other user interface components can include a display device, such as a monitor and an input device, such as a keyboard, keypad, mouse, touch-sensitive element of a touch-screen display, or similar device.

Each of the submitter and analyst terminals 18, 16 is configured to run a user agent, such as a web browser or other suitable program. The web browser may reference locally stored data, which can include cookies and similar information.

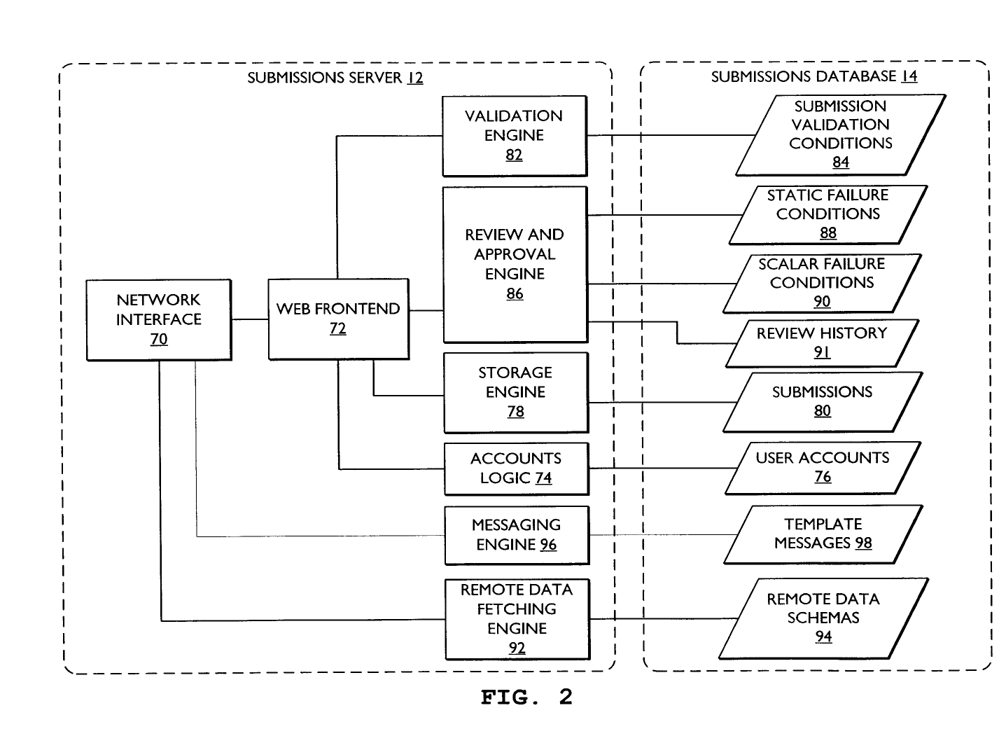

FIG. 2 shows the submissions server 12. The submissions server 12 operates on a processor and connected memory.

The processor is configured to execute instructions, which may originate from the memory or a network. The processor may be known as a CPU. The processor can include one or more sub-processors or processing cores. The memory includes a non-transitory machine-readable medium that is configured to store programs and data. The memory can include one or more short-term or long-term storage devices, such as a solid-state memory chip (e.g., DRAM, ROM, non-volatile flash memory), a hard drive, an optical storage disc, and similar. The memory can include one or both of fixed components that are not physically removable (e.g., fixed hard drives) and removable components (e.g., removable memory cards). The memory allows for random access, in that programs and data may be both read and written. The processor and memory operate in conjunction to execute the engines, databases, and similar components discussed herein.

Although one submissions server 12 is shown, it is contemplated that more than one server can be used to implement the functionality described. Various functional components can be provided to various servers. The servers need not be co-located.

The submissions server 12 further includes a network interface 70 that is configured to allow the submissions server 12 to communicate with other servers or terminals across one or more networks. The network interface 70 can include one or more of a wired and wireless network adaptor and well as drivers for controlling such adaptors.

The submissions server 12 further includes a web frontend 72 or similar component configured to provide at least a user interface to the submitter and analyst terminals 18, 16 connected to the submissions server 12. The web frontend 72 supports data entry of submissions via web forms and further supports output of related data and information concerning submission entry. Various other components of the submissions server 12 are accessible to the terminals 18, 16 through the web frontend 72.

The submissions server 12 further includes accounts logic 74 configured to handle user log-in, authentication, and security. User accounts 76 are stored at the submissions database 14. Claims-based authentication can be used, in which case the user accounts 76 store information concerning trusted identity providers and various access rights based on asserted and verified claims.

User accounts 76 store information concerning individuals, such as the identities of individuals in association with issuers or other market participants, indications of role and employment for individuals regarding capital market submissions, and professional relationships with other parties. The user accounts 76 information can accordingly be used to identify relationships among users and permissions granted to users. It is contemplated that the user accounts 76 may be accessible via the wide-area network 20 instead of, or in addition to, the intranet 24, so as to facilitate remote access by users, and particularly those users who may be located in remote domains. It is further contemplated that an individual user may serve one or more roles for various market participants, and hence, that user's account 76 can be associated with unique permissions for such various market participants.

The submissions server 12 further includes a storage engine 78 configured to store submissions 80 at various stages of progress. Work-in-progress submissions 80 are stored in the submissions database 14. A submitting user may store a submission until it can be completed at a later time. A completed submission may be stored pending analyst review, pending payment completion, or pending transfer to the repository.

The submissions server 12 further includes a validation engine 82 configured to apply submission validation conditions 84 to submissions. Submission validation conditions 84 are stored in the submissions database 14 and configurable by the market entity. Submission validation conditions 84 include any combination of indications of mandatory form fields, types of data permitted in form fields, permissible ranges of numbers or expressions of text, and similar. The validation engine 82 provides immediate feedback to the submitter terminals 18 to prompt immediate correction of inputted information. Feedback can include, for example, messages displayed on the form at a submitter terminal 18. The submission validation conditions 84 advantageously prevent submissions that have negligible or zero chance of being successfully processed (e.g., approved or completing review). Hence, in the case of private placements, the submission validation conditions 84 express the fundamental and immutable policies of the exchange organization or other market entity and also serve to catch trivial errors in data entry.

The submissions server 12 can further include a review and approval engine 86 configured to apply at least one static failure condition 88 and at least one scalar failure condition 90 to the data contained in the submissions. Static and scalar failure conditions 88, 90 are stored in the submissions database 14. A static failure condition 88 identifies an element of submission data that must be present or absent. The presence or absence of such an element meets a respective static failure condition 88 and the respective submission fails. For example, the presence of any data in a particular form field is a static failure condition that, when met, causes the review and approval engine 86 to indicate a failure of the submission. A scalar failure condition 90 identifies submission data that is to conform to an inequation in order for the scalar failure condition to be met. Conformance to the inequation triggers failure of the submission. For example, when a numerical value contained in a particular form field meets or exceeds a specified numerical limit, a scalar failure condition is met and the submissions fails. Several static and/or scalar failure conditions 88, 90 can be logically combined to form complex failure conditions for a particular element or group of elements of data. For instance, a complex failure condition is met when a first field contains data and when a second field has a value of less than an upper limit or when a third field has a value that exceeds a lower limit. The static failure conditions 88 and scalar failure conditions 90 are configurable.

In various implementations, the review and approval engine 86 conducts one or both of review and approval of submissions. The term “review and approval engine” is not intended to limit functionality and only one of review and approval need be performed. When only one of these functions is to be performed, the review and approval engine 86 may be referred to as a review engine or an approval engine. Further, in implementations where both review and approval are performed, there are no limitations on where and when these functions are performed or which entity or entities trigger these functions. For instance, the submissions server 12 can associate the review function for a first group of analyst terminals 16, while a second group of analyst terminals may be associated with the approval function implemented by the submissions server 12. Such associations can be enforced by user permissions. Reviewed submissions may remain in the system for days, months, years, or indefinitely pending approval, with the indefinite period of time being contemplated as useful when approval of submissions is performed upon audit.

The web frontend 72 is further configured to display stored submissions 80 to logged-in analysts at analyst terminals 16, and particularly display open and failed submissions 80 to the analyst terminals 16 along with indications of the relevant failure conditions that were met, as well as review history data 91 describing any past failures, resubmissions, and changes in the submission data. The review and approval engine 86 is further configured to receive analyst approval and failure indications from the analyst terminals 16. Analyst approval and failure indications are saved in association with the submissions 80 as review history data 91.

The review history data 91 encapsulates any past failures, resubmissions, and changes in the submission data for convenient and quick review at the analyst terminals 16. Further, the review history data 91 can contain triggers that cause the review and approval engine 86 to pull additional data, which may not form part of the submission 80 under review, from data sources (e.g., the news data source, identity information, etc.) to provide the analyst terminal 16 with supplementary data to expedite the review process. The review and approval engine 86 can be configured to present the review history data 91 in conjunction with the submission 80 itself in a review package to the analyst terminal 16. The review and approval engine 86 generating and presenting the review package may be performed each time review is required, or only upon a first instance of a failure condition being met. The review and approval engine 86 pre-fetching supplementary data from other sources based on the review history data 91 can make the analyst review process more efficient. The review history data 91 can be stored indefinitely and constitutes an audit trail for the submission and its final state.

The submissions server 12 further includes a remote data fetching engine 92 that operates according to remote data schemas 94, which are stored in the submissions database 14. The remote data fetching engine 92 is configured to obtain data from sources available over the wide-area network 20 and the intranet 18. The obtained data is used to evaluate particular static and scalar failure conditions 88, 90. The remote data fetching engine 92 is triggered to fetch particular remote data based on data specified in submissions and applicable static and scalar failure conditions 88, 90. Alternatively, the remote data fetching engine 92 can be configured to continually harvest remote data and store such for potential future need. It is contemplated that the remote data is asynchronous to the submission data. Accordingly, the remote data fetching engine 92 can be configured to periodically attempt to obtain the remote data relevant for a particular submission over a configurable time period. If the relevant data cannot be obtained within the configurable time period, then the associated static and/or scalar failure condition 88, 90 is met and the submission fails.

The remote data schemas 94 can specify parsing rules for content containing the remote data in case the remote data forms part of the content, as may occur, for example, with press releases that indicate a price or other numerical values. Parsing rules can include regular expressions and may further be specific to remote data sources. That is, different parsing rules can be made for different websites known to publish press releases, so as to accommodate the different structures of such websites. Other remote data, such as trading prices, may be stored in a structured manner, and the schemas may be suitably selected.

The submissions server 12 further includes a messaging engine 96 coupled to the network interface. Associated template messages 98 are stored in the submissions database 14. The messaging engine 96 is configured to generate alerts for the submitter terminals 18 and analyst terminals 16, as well as other messages for users of such terminals or for other recipients. The template messages 98 can contain configurable static content and fields that are populated by the messaging engine 96 based on a particular message required. An alert to an analyst terminal 16 may have fields populated with data from portions of the submission that met failure conditions, so that a human analyst can readily and quickly assess the submission. The messaging engine 96 can be configured to reference the accounts logic 74 and user accounts 76 data to automatically select recipients for messages (e.g., alerts or notifications). Automatic recipient selection is configurable and supports multiple recipients. The messaging engine 96 may be implemented as an electronic mail (email) application. The messaging engine 96 can be configured to use secure protocols, such as Hypertext Transfer Protocol Secure (HTTPS) and Secure Socket Layer (SSL), for instance.

In operation, the submissions server 12 receives a log-in request from a submitter terminal 18 and processes such using the accounts logic 74 and user accounts data 76. The logged-in submitter terminal 18 may then start a new submission or load a saved submission 80 from the database 14. When the submitter terminal 18 indicates that the submission is complete, the validation engine 82 validates the submission and provides immediate feedback to the submitter terminal 18. Once successfully validated, the submission 80 is then stored and the review and approval engine 86 evaluates the static and scalar failure conditions 88, 90 for the submission. Any remote data required to evaluate the static and scalar failure conditions 88, 90 is obtained using the remote data fetching engine 92. If none of the static and scalar failure conditions 88, 90 are met, the submission is marked as having been automatically processed without human evaluation and interaction. This advantageously allows fast and efficient processing of submissions. If any of the static and scalar failure conditions 88, 90 are met, the submission is stored and an alert is sent to an analyst terminal 16 for review. The stored submission 80 is presented to the analyst terminal 16 in a review package that can also include the triggered static and scalar failure conditions 88, 90, data not part of the submission pulled from data sources, and relevant historic review data 91, so as to increase efficiency and speed even when analyst review is needed.

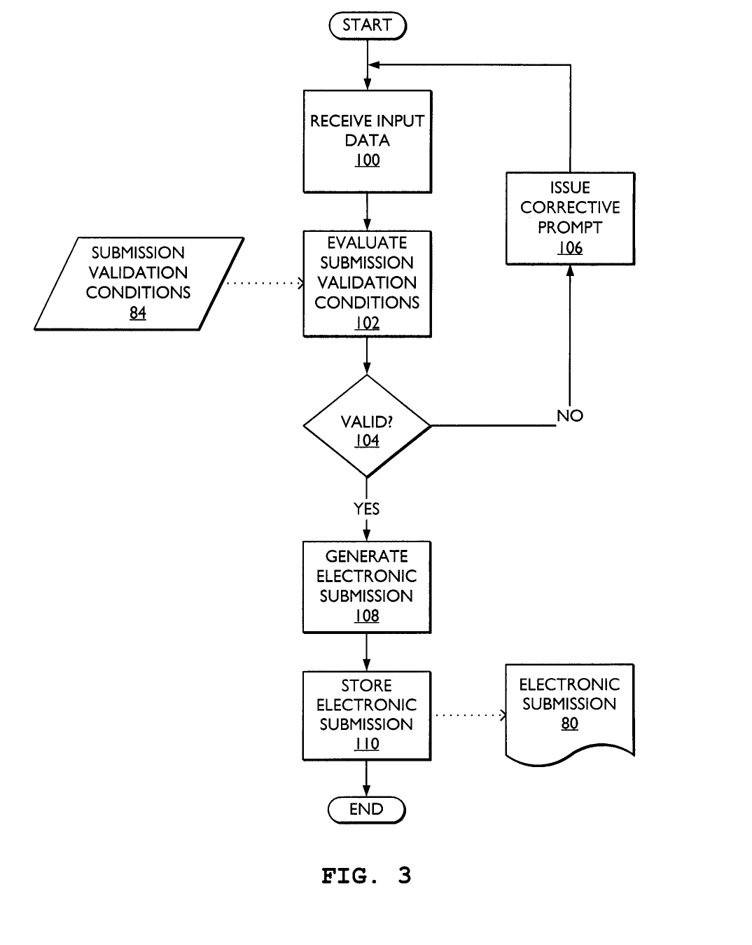

FIG. 3 shows an example of a submission validation process. The process can be performed by the validation engine of FIG. 2 or by another component. The system 10 is referenced in the below description, but is not limiting.

At step 100, data is inputted into a submission form displayed at, for example, a submitter terminal 18. The terminal 18 then submits the form data and, at step 102, validation conditions 84 are evaluated. Examples of validation conditions for private placements include a mandatory indication of the issuer and placees, the availability of a market price, issuance of securities to a finder or agent being limited to a maximum, and similar.

At step 100, data is also automatically obtained from data sources based on known data. That is, when a submitter terminal 18 creating a new submission is associated with a particular entity, data for that entity may be obtained from the identity information source, compliance and disclosure data source, and trading data source (FIG. 1), from the user accounts data 76 (FIG. 2), as well from as other sources. Obtaining data for the submission in this way may also be considered validation.

If validation fails at step 104, that is, if any validation condition is not met, then a respective corrective prompt is issued, at step 106, to the submitter terminal 18. Such prompts may take the form of text that indicates which form field failed validation and why. The submitter terminal 18 can correct the respective data and resubmit the form.

Once validation is successful, an electronic submission containing the inputted data is generated, at step 108. The submission is then stored, at step 110, as an electronic submission 80 at, for example, the submission database 14 (FIG. 2). The stored submission 80 is now an open submission pending review or approval.

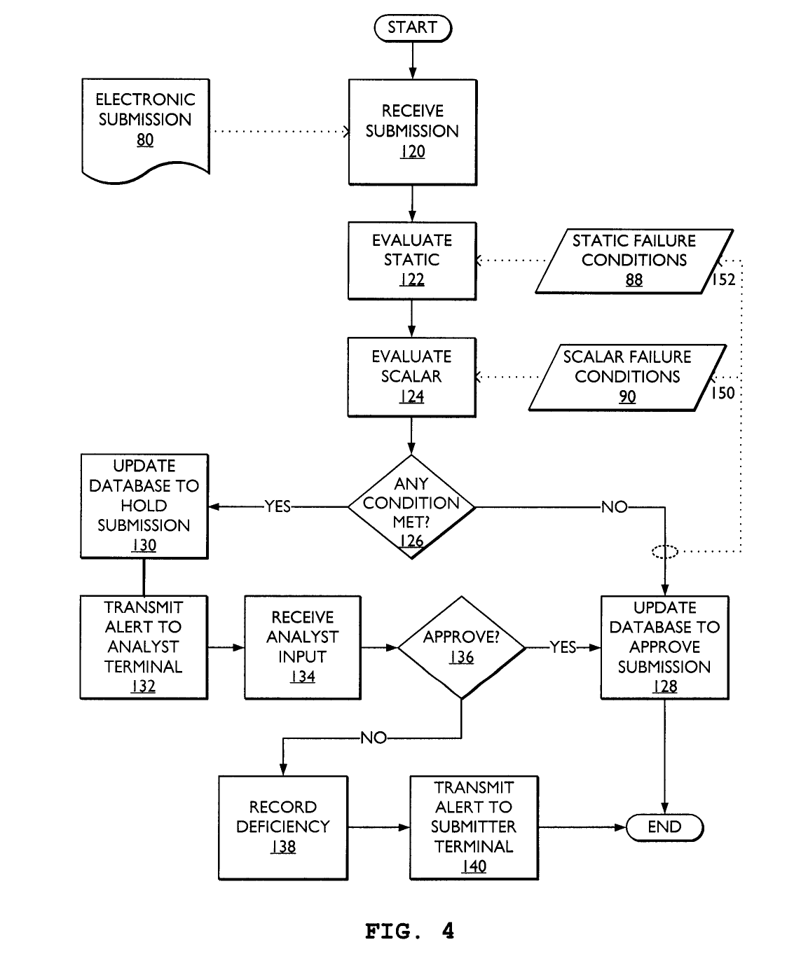

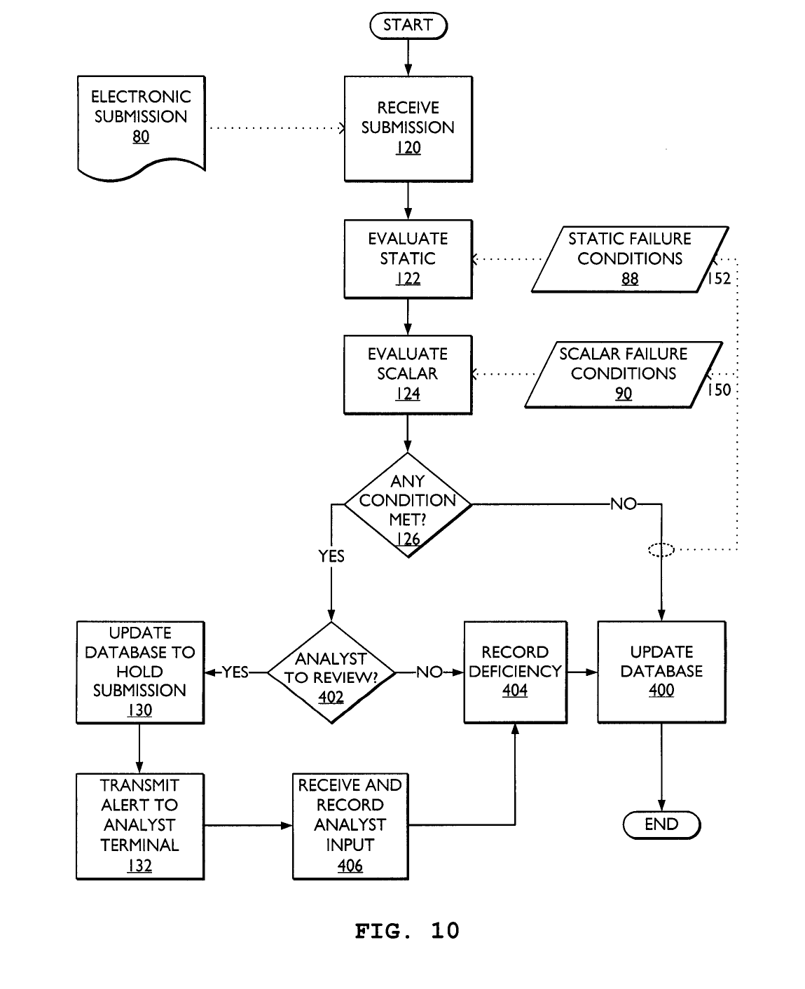

FIG. 4 shows an example of a submission approval process. This process can be used for submissions that required approval. For submissions requiring review only, refer to FIG. 10. The submission approval process can be performed by the review and approval engine of FIG. 2 or by another component. The system 10 is referenced in the below description, but is not limiting.

At step 120, a validated electronic submission 80 is received. This can occur immediately after submission validation (FIG. 3). The data of the submission 80, or the relevant data elements thereof, can be fetched from the submissions database 14.

Next, at step 122, static failure conditions 88 are evaluated. The relevant data contained in the electronic submission 80 is evaluated against at least one static failure condition. Step 122 checks for any indicated element of the data that is to be present or absent for the static failure condition to be met.

At step 124, scalar failure conditions 90 are evaluated. The relevant data contained in the electronic submission 80 is evaluated against at least one scalar failure condition. Step 124 checks whether any indicated elements of the data conform to one or more inequalities, and if so, determines that a scalar failure condition 90 has been met.

Evaluation of static and scalar failure conditions 88, 90 can be performed in any order and may be performed simultaneously or as part of the same operation. Steps 122 and 124 and the order thereof are merely illustrative.

In steps 122 and 124, data required to evaluate any failure condition, beyond the data contained within the submission 80, can be obtained from the identity information source, compliance and disclosure data source, and trading data source (FIG. 1), from the user accounts data 76 (FIG. 2), as well as other sources.

At step 126, it is determined whether any one or more of the static and scalar failure conditions 88, 90 have been met. Upon completion of the evaluation, when no such failure conditions have been met, the submissions database 14 is updated to indicate that the submission has been approved, at step 128. Such update may include an indication that the submission has been approved without human intervention or review. An approval notification, such as an email, may be sent to the respective submitter terminal 18, and such notification may indicate that the submission was automatically approved.

If any of the static and scalar failure conditions 88, 90 is determined to be met, the submissions database 14 is updated to indicate that the submission requires further analysis, at step 130. The submission is held for review input from an analyst terminal 16.

Steps 122-126 may be implemented so that the check of step 126 is performed as each failure condition is evaluated. Completion of evaluation of all failure conditions is not required to determine that one such condition has been met. Steps 122-126 may be implemented as a series of conditional statements (e.g., if-then statements).

For a held submission, at step 132, an alert is transmitted to one or more analyst terminals 16. The alert indicates to a human analyst that review of the submission is required. The alert can contain data of the submission, particularly the data that triggered the failure condition. The alert may be sent via electronic mail or other technique.

Subsequently, analyst input is received for the held submission, at step 134. Such input can contain an approval indication, a refusal indication, a selection of one or more predetermined reasons for approval or refusal, a textual or other type of comment, or similar. The analyst input is not particularly limited.

At step 136, when an approval indication is received from the analyst terminal 16, the submissions database 14 is updated to indicate that the submission has been approved, at step 128. Such update may include an indication that the submission has been approved after analyst review. Such update may further include analyst input from step 134 concerning the approval. An approval notification, such as an email, may be sent to the respective submitter terminal 18, and such notification may indicate that the submission was approved by an analyst and may further include analyst input from step 134 concerning the approval.

When the submission is not approved, one or more deficiencies prompting the refusal are recorded, at step 138. Deficiencies may be indicated by analyst input from step 134. Deficiencies can be recorded in association with the submission 80 in the submissions database 14.

Concerning a rejected submission, an alert is transmitted to one or more submitter terminals 18. The alert indicates the reason for the refusal to the submitter. The alert can contain data of the submission, particularly the data that triggered the refusal, and may further contain analyst input from step 134. The alert may be sent via electronic mail or other technique.

After refusal, the submitter terminal 18 can resubmit an updated submission 80 at step 120 and the process is repeated. Indications of failure conditions met for the past version of the submission as well as analyst input concerning the past version may be retained in association with the updated submission 80, so that any subsequent review needed is informed of such.

The scalar failure conditions 90 are configurable and can advantageously be updated based on rate of successful processing of electronic submissions 80 meeting none of the failure conditions 88, 90. That is, the rate that submissions bypass steps 130-140 can be measured, as shown at 150, and used as feedback to adjust the scalar failure conditions 90. For example, if 78% of submissions are automatically approved, one or more of the scalar failure conditions 90 can be relaxed. Subsequently, it may be determined that 80% of submissions are automatically approved, thereby reducing the amount of human intervention and judgement required for individual submissions. A target automatic approval rate can be set and one or more of the scalar failure conditions 90 can be adjusted to track the target rate. That is, the rates of submissions being automatically processed and requiring further review by an analyst terminal can be controlled. Adjustment to the one or more of the scalar failure conditions 90 may be proportional to a difference between an actual rate of automatic approval and the target rate. Integral and derivative relationships may additionally or alternatively be used. Process control techniques (e.g., PI, PID, etc.) may be employed. The preceding is not limiting, and a user-interface for manual adjustment or manual override to automatic adjustment can be implemented.

Similarly, the static failure conditions 88 are configurable and can advantageously be updated based on rate of successful processing of electronic submissions 80 meeting none of the failure conditions 88, 90. That is, the rate that submissions bypass steps 130-140 can be measured, as shown at 152, and used as feedback to adjust the static failure conditions 88.

Outcomes of further analysis by analyst terminals 16 can also be used to adjust the failure conditions to control the rates of submissions being automatically processed and requiring further review. These outcomes can be taken from the output of step 136, for example, and can include information reflecting whether or not the submission was approved and if deficiencies were encountered on the path to approval, and the nature and quantity of any deficiencies. The review and approval engine can be configured to track such outcomes and recommend adjustments to the failure conditions 88, 90. For example, if it is determined that analyst terminals 16 consistently reject submissions having a certain attribute, then that attribute can be quantified in a new failure condition or by adjusting an existing failure condition.

The guidelines under which analysts review and approve/refuse submissions are different from the scalar and static failure conditions discussed herein. Analyst guidelines rely on professional judgement, and the systems and processes discussed herein supplement and focus professional judgement, so that submissions needing the most professional judgement tend to be provided to analysts at higher frequency than submissions needing the least. The system can be configured to output reports containing rates of submissions processed with and without review by an analyst and the outcomes of such processing (e.g., approved, refused, etc.), if any. This can allow high-level review of analyst performance and behaviour and may permit intelligent adjustment of analyst guidelines.

The submissions server 12 can be configured to output information about approved submissions sharing commonality in data content and/or failure conditions met or unmet. Such information can include rate of automatic approval, rate of analyst approval, rate of analyst refusal, and similar. Such information can be presented to one or more analyst terminals 16 or other terminals associated with the operations of the submissions workspace. Coupled to such presentation may be a user interface that allows adjustment of one or more failure conditions. The submissions server 12 may be configured to employ statistical calculations when presenting or recommending adjustment of the one or more failure conditions.

In effect, the failure conditions, and in particular the scalar failure conditions, quantize past trends in human decisions on individual submissions that have been found acceptable and apply such quantized judgement in an efficient and unbiased manner to future submissions. Automatic approval of a submission is thus performed by a machine acting as a proxy for human analysts. This advantageously frees analysts to spend more time on submissions of greater complexity.

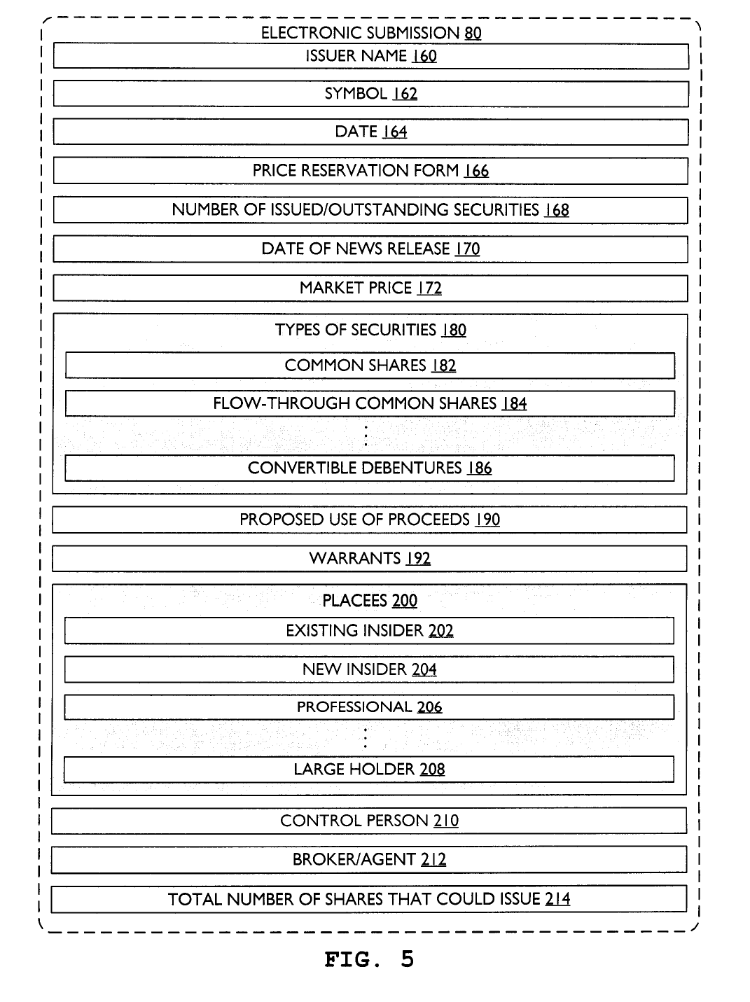

FIG. 5 is a diagram showing an example submission data structure for private placements. Other data structures are contemplated for other implementations and the data structure shown is merely illustrative. The data structure is abridged for explanatory purposes, and additional data elements are contemplated for actual implementation. The submission data structure may be used as the basis for a submission form used at the submitter terminals 18 to enter submission data. The data elements discussed can be single fields, groups of fields, data substructures, relationships to remote data fields, addresses of attachments or other files, calculated fields (e.g., summations of other fields), or similar, and may include internal logic such as permissible data types, permissible data lengths, and validation conditions.

An issuer name data element 160 and symbol data element 162 uniquely identify the issuer of the private placement. A date element 164 is for receiving the timestamp of the submission. A price reservation data element 166 indicates data of a price reservation form, such as the data itself or a link to an attached form. The number of issued/outstanding shares, or other securities, is stored in its data element 168. A data element 170 for a date of news release data is provided. Further, a market price data element 172 is provided. Data elements, such issuer name 160, symbol 162, number of issued/outstanding securities 168, and market price 172, can be automatically populated based on the identity of the submitter logged into the submitter terminal 18 corresponded to identity information and data from trading data sources and other data sources. The validation engine (FIG. 2) can be configured to perform such automatic population or limit choices presented to the submitter terminal 18 when ambiguity exists.

A data element 180 for the types of securities permitted for a private placement have data elements for storage of data for common shares 182, flow-through common shares 184, and convertible debentures 186. The data elements 182-186 also store a maximum number of shares to be issued or converted, a subscription price, and other relevant information. That is, the common shares data element 182 indicates the maximum number of common shares to be issued and the subscription price. The same applies for the other security-type data elements 184, 186. In other implementations, various different kinds of securities can be handled in a manner similar to, or the same as, the example of shares discussed herein.

Data elements 190, 192 for information concerning the proposed use of proceeds and warrants are provided.

A placee data element 200 stores identities of individuals or other entities in data elements for existing insiders 202, new insiders 204, registered market professionals 206, larger holders 208 (e.g., 5% or greater holders), and individuals having relationships thereto. Further, the data elements store 202-208 the numbers of shares to be purchased for the respective individual or entity, the number of currently held shares, and other information specific to the placement. That is, the existing insider 202 data element is configured to store an identity of each insider as well as the number of shares to be purchased by the insider and the number of shares currently held by the insider. The same applies to the other placee-specific data elements 204-208.

A control person data element 210 stores the identity and other information of a control person. The control person data element 210 also indicates whether the control person is diluted or undiluted.

A broker/agent data element 212 stores the identity and other information of one or more brokers and/or agents for the private placement.

A total data element 214 stores a total of the number of shares or other securities that could be issued for the placement represented by the submission 80. The total data element 214 is calculated based on data contained in the data elements 182-186 for the individual securities.

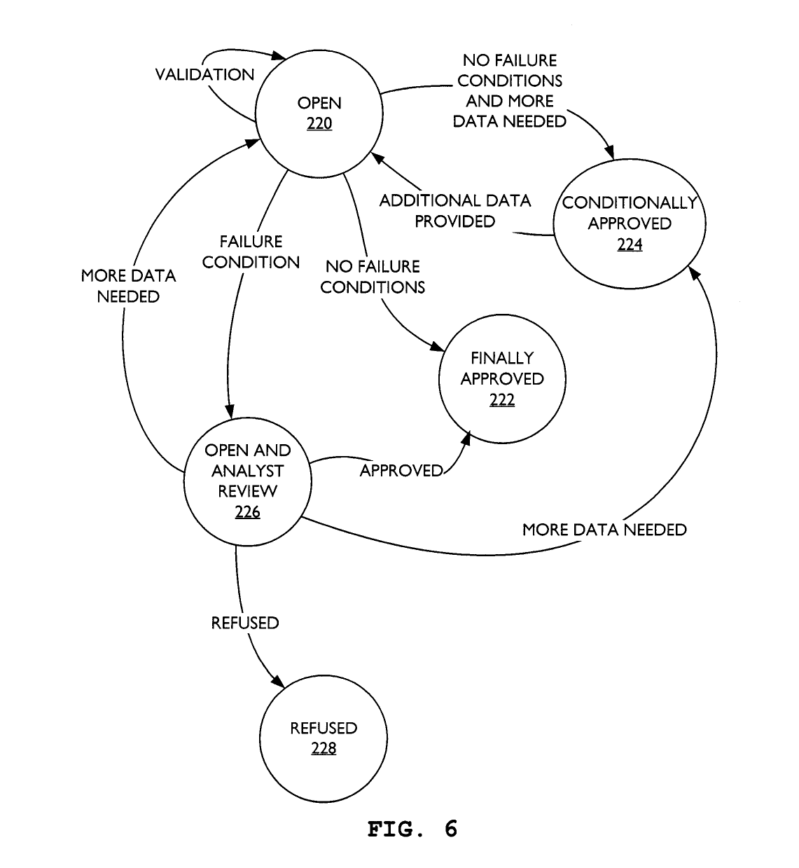

FIG. 6 shows a state diagram for submission approval. Submissions can have various states as shown. A submission is open 220 when data is being provided by a submitter terminal 18 and while validation is performed. The open state 220 may be returned to upon a request for additional data required by analyst review or required to complete a conditionally approved partial submission. A validated submission that meets no failure conditions and contains all necessary data becomes finally approved 222. When further data or supporting documentation is needed, the submission becomes conditionally approved 224. Any failure condition causes the submission to remain open and undergo analyst review 226, which may lead to the submission being refused 228, finally approved 222, conditionally approved 224 with an indication that more data is required, or returned to the open state 220 with an indication that more data is required. Transition from the open with analyst review state 226 to the open state 220 may indicate a “soft” rejection, which requires corrective action on the part of the submitter or further data before analyst review can be completed. Transition from the open with analyst review state 226 to the conditionally approved state 224 indicates that the submission has passed analyst review but requires additional information to become approved. However, such additional data may still trigger further analyst review. Confirmation of payment to the exchange by the issuer may also be considered additional data that is required to be provided to transition out of the conditionally approved state 224. A submission's state may be stored in the submission data itself (e.g., non-editable field) or stored in another data structure associated with the submission. Alternatively, the submission's state may be derived from the data each time it is required.

The loops between states 220, 224, and 226 represent a review process and review history data 91 (FIG. 2) may be generated at each state for display at the analyst terminal 16 at state 226 in conjunction with the triggered static and scalar failure conditions 88, 90, so as to increase efficiency and speed even when analyst review is needed. It is also noted that the review process remains in the system 10, in that the messaging engine 96 (FIG. 2) manages communications between the analyst terminal 16 and the submitter terminal 18. That is, the messaging engine 96 sends notifications to the submitter terminal 18 and further presents the analyst terminal 16 with the submission, review history data 91, and triggered static and scalar failure conditions 88. This advantageously maintains security for the submission 80 and increases the chance that the entire review history is tracked in the system and helps avoid extra-system communications about the submission 80, such as phone calls and general email.

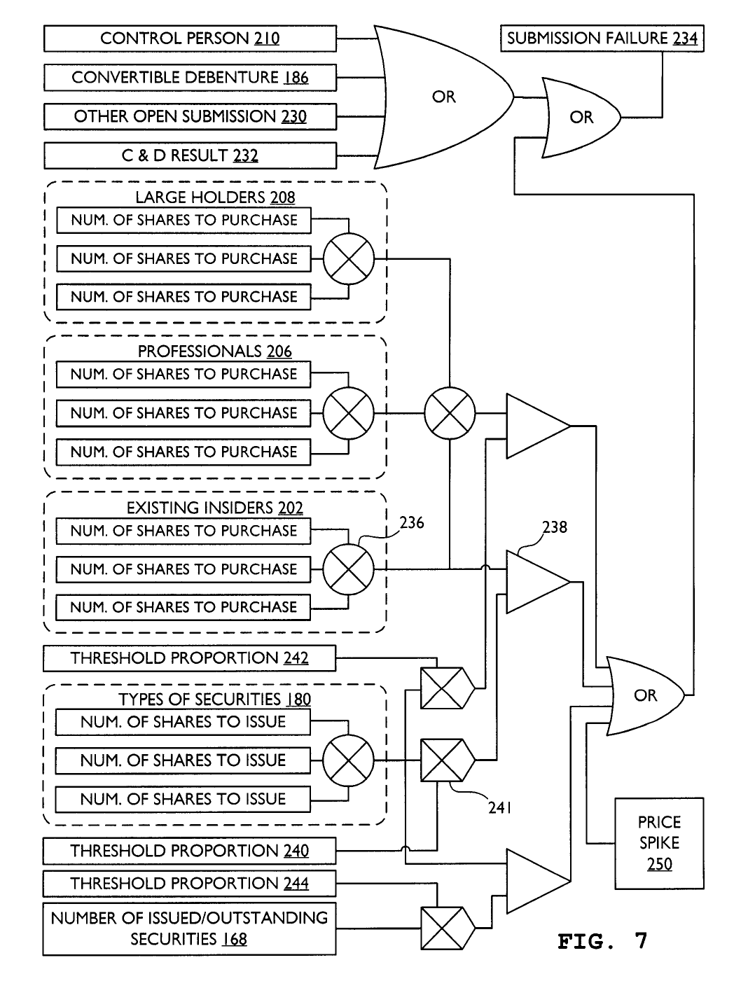

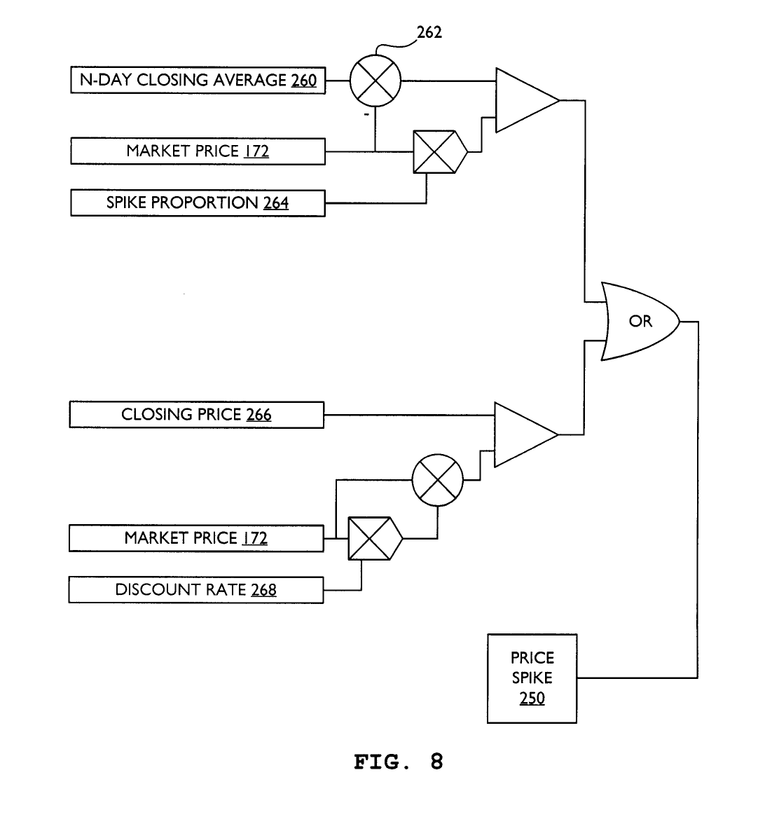

FIGS. 7 and 8 show examples of static and scalar conditions, and the logical relationships thereof, for a private placement example.

With reference to FIG. 7, static failure conditions include the existence of any one or more of an indication of a control person 210, a predetermined specific type of security (e.g., a convertible debenture) 186, other open submissions for the same issuer 230, and a compliance and disclosure result 232. Any of such static failure conditions causes the submission to fail 234 the automatic process and triggers analyst review. The submission server 12 can determine indication of a control person 210 and convertible debenture 186 by inspecting the submission data (FIG. 5). The submission server 12 can detect other open submissions for the same issuer 230 by querying the submissions 80 in the submissions database 14. The submission server 12 can determine a compliance and disclosure result 232 by querying the compliance and disclosure server 44 (FIG. 1) using relevant data contained in the submission 80. In other examples, another type of security is associated with a static failure condition.

Scalar failure conditions relate to security (e.g., share) quantities and price levels. Data for evaluating the scalar failure conditions can be obtained from the submission 80 itself and by querying the trading data server 48. Any one scalar failure condition triggers failure 234 of the submission irrespective of the static failure conditions.

An indication of an excessive placement amount to one or more insiders is determined by summing 236 the numbers of securities (e.g., shares) to be purchased by all existing insiders 202 and comparing 238 the total to an existing-insider threshold proportion 240 of a total number of securities to issue for the various types of securities 180 in the placement. That is, the total number of securities to issue is multiplied 241 by the existing-insider threshold proportion 240 to obtain an existing-insider threshold that is applied as a maximum for comparison to the existing insider purchases. In some examples, the existing-insider threshold proportion 240 can be selected as between about 15% and about 35% of the total number of shares to issue in the placement. For example, an aggregate number of shares for purchase by existing insiders of greater than X % of all shares to be issued meets this scalar failure condition and causes the submission to fail automatic processing. In FIG. 7, the summing element 236, comparator 238, and multiplier 241 are operational elements that represent an inequation that limits existing insider participation. Like operational elements are shown for other inequations of other scalar failure conditions discussed herein.

Another scalar failure condition is an excessive placement amount to informed participants, such as existing insiders 202, large holders 208, and registered market professionals 206. A total number of securities to be purchased by all existing insiders 202, large holders 208, and registered market professionals 206 is calculated and compared to an informed-participant threshold proportion 242 of a total number of securities to issue for the various types of securities 180 in the placement. That is, the total number of securities to issue is multiplied by the informed-participant threshold proportion 242 to obtain an informed-participant threshold that is applied as a maximum for comparison to the planned purchases by existing insiders 202, large holders 208, and registered market professionals 206. In some examples, the informed-participant threshold proportion 242 can be selected to be between about 35% and about 65% of the total number of shares to issue in the placement. For example, an aggregate number of shares for purchase by informed participants 202, 206, 208 of greater than Y % of all shares to be issued meets this scalar failure condition and causes the submission to fail automatic processing.

Another scalar failure condition is an excessive placement amount relative to a number of issued and outstanding securities 168. A total number of securities to issue for the various types of securities 180 in the placement is compared to a placement threshold proportion 244 of the number of issued and outstanding securities 168. That is, the total number of securities issued and outstanding 168 is multiplied by the placement threshold proportion 244 to obtain a placement threshold that is applied as a maximum for comparison to the total number of securities to issue in the placement represented by the submission. If the total number of securities to issue in the placement exceeds the placement threshold, then this scalar failure condition is met and the submission fails automatic processing. In some examples, the placement threshold proportion 244 can be selected as between about 15% and about 35% of the total number of issued and outstanding shares 168.

Another scalar failure condition is an indication of a price spike 250. If the price of the security has spiked near the time of the placement, then the scalar failure condition is met and the submission fails automatic processing.

FIG. 8 shows an example of a price spike determination for the private placement example. The submission server 12 is configured to receive price data from the remote trading data server 48 via the intranet 24, the price data being used by the submissions server to arrive at one or more calculated values. The submission server 12 checks for a price spike using an inequation by comparing data elements of the submission 80 to the calculated values and to configurable values stored with the scalar failure conditions 90.

A closing average price 260 for the security over a selected number of days is calculated. Non-trading days may be excluded and trading days with no trades may have their close prices ignored. The number of days may extend back from a price reservation date contained within the submission 80 data.

The market price 172 is subtracted 262 from the N-day closing average 260 and the result is compared to a price spike threshold, which is determined by multiplying the market price 172 by a spike proportion 264. If the difference between the N-day closing average 260 and the market price 172 exceeds the spike proportion 264 of the market price 172, then a price spike 250 is determined to have occurred and this scalar failure condition is met. The closing average price 260 is based on N days and the spike proportion 264 may be selected as a suitable percentage, Z. Hence, the inequation represented by this scalar failure condition is:

N-Day Closing Average−Market Price>Z*Market Price

The closing price 266, as of the price reservation date, of the security is also compared to the market price 172 modified by a discount rate 268. If the closing price 266 exceeds the market price 172 as increased by the discount rate 268, then a price spike 250 is determined to have occurred and this scalar failure condition is met. The inequation represented by this scalar failure condition is:

Closing Price>Market Price+Market Price*Discount Rate

Example discount rates range from about 35% to about 5% and may be configured as dependent on market price. Larger spikes can be tolerated for smaller market prices. In some examples, a market price of less than or equal to $0.50 corresponds to a discount rate of about P %, a market price of greater than $0.50 but less than or equal to $2.00 corresponds to a discount rate of about Q %, and a market price of greater than $2.00 corresponds to a discount rate of about R %.

Specific suitable values for the above percentages and quantities can be selected by the entity that operates the system according to any number of factors and considerations.

Any of the scalar failure conditions discussed above with reference to FIGS. 7 and 8 can be used alone or in any combination. The scalar failure conditions can be implemented procedurally, as a lookup table, in the form of logic gates, or by using another technique.

The values of the existing-insider threshold proportion 240, the informed-participant threshold proportion 242, the placement threshold proportion 244, the number (N) of days for the closing average 260, the spike proportion 264, and the discount rate 268 are configurable and stored in the scalar failure conditions 90 in the submissions database 14. These values, alone or in combination, may be adjusted manually or via a feedback loop based on a rate of submissions that are automatically processed without human intervention or review. The isolation of these parameters and their selected values advantageously allow tuning of the system 10 to increase speed and efficiency of private placement processing and reduce the electronic communications bandwidth and storage space required to effect review and/or approval.

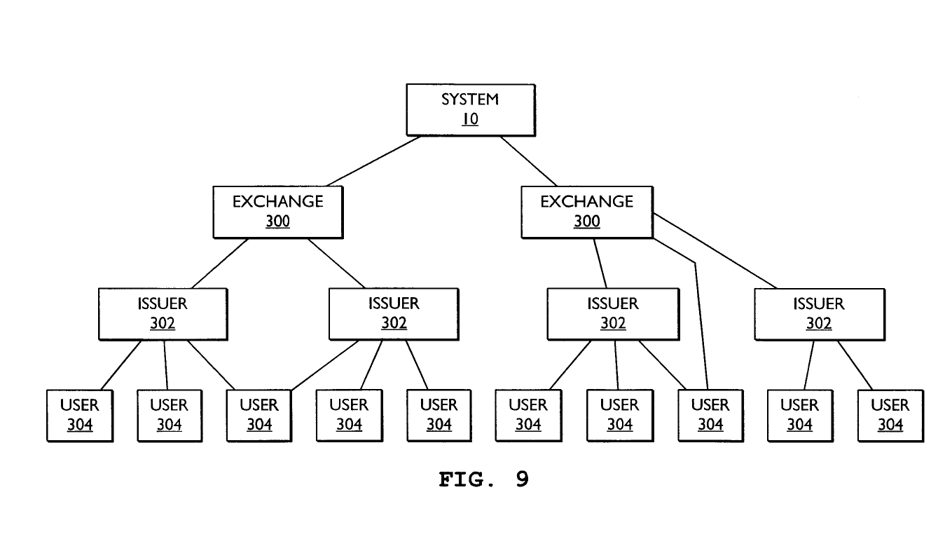

FIG. 9 shows relationships among the system 10, exchanges 300, issuers 302, and users 304 for the private placements example. The system 10 can host one or more exchanges 300 operated by various exchange entities. Each exchange 300 may have its own submissions workspace or may share a common submissions workspace. Exchanges 300 may subscribe to the services provided by the system 10. Each exchange 300 may support various issuers 302, who may subscribe to the services offered by the exchange 300. A population of users 304, such as submitters and analysts, support the issuers 302 and may be employed or contracted by the issuers 302 or exchanges 300. The same user 304 may serve multiple issuers 302. Various users 304 may perform functions internal to the exchanges 300. In terms of claims-based authentication, the system 10 is a trusted identity provider, the exchanges 300 make claims to the system 10, and the issuers 302 make claims to the exchanges 300, and the users 304 make claims to the issuers 302 and exchanges 300.

FIG. 10 shows an example of a process for review of submissions. This process can be used for submissions that do not require immediate approval, and further may not require immediate analyst review. Met failure conditions can be tracked for immediate or later analyst review, if any. This process can be performed by the review and approval engine of FIG. 2 or by another component. The system 10 is referenced in the below description, but is not limiting. Further, like-numbered steps have already been described with reference to FIG. 4 and such description will not be repeated here.

At step 126, it is determined whether any one or more of the static and scalar failure conditions 88, 90 have been met. Upon completion of the evaluation, when no such failure conditions have been met, the submissions database 14 is updated to indicate that the submission has been automatically processed without analyst review, at step 400. A suitable notification, such as an email, may be sent to the respective submitter terminal 18, and such notification may indicate that the submission was automatically processed.

If any of the static and scalar failure conditions 88, 90 is determined to be met at step 126, it is then determined whether analyst review is required, at step 402.

If no analyst review is required, then the met failure conditions are recorded as deficiencies, at step 404, and the database 14 is updated to reflect that the submission 80 was automatically processed and that deficiencies exist. Subsequently, at any future time, a query may be executed to pull from the database 14 deficient submissions for further action, such as approval, requests for additional data, or similar.

If analyst review is required, then the submissions database 14 is updated to indicate that the submission requires further analysis, at step 130. The submission is held for review input from an analyst terminal 16.

For a held submission, at step 132, an alert is transmitted to one or more analyst terminals 16. The alert indicates to a human analyst that review of the submission is required. The alert can contain data of the submission, particularly the data that triggered the failure condition. The alert may be sent via electronic mail or other technique.

Subsequently, analyst input is received for the held submission, at step 406, and recorded at the database 14. Such input can contain comments on the submission, further data that the analyst has reviewed with the submission 80, or similar. The analyst input is not particularly limited.

Then, at step 404, the database 14 is updated to reflect that the submission 80 was not automatically processed and that deficiencies exist. The deficiencies are recorded along with the analyst input from step 406. Subsequently, at any future time, a query may be executed to pull from the database 14 deficient submissions and analyst input concerning such.

The techniques discussed herein offer an objective and transparent way to process submissions and may reduce human bias, reduce time required for review and/or approval, and increase submission throughput. The invention does not replace human judgement as a whole, but replaces instances of human judgement that are not required with quantized judgement, thereby freeing human analysts to review submissions that cannot be properly machine reviewed. In addition, the techniques improve the operation and efficiency of submissions servers and networks by saving communications bandwidth and storage space that, in the past, analysts often required for substantial amounts of internal and external electronic communications to process.

While the foregoing provides certain non-limiting example embodiments, it should be understood that combinations, subsets, and variations of the foregoing are contemplated. The monopoly sought is defined by the claims.

1. A method of updating a database with data pertaining to capital market transactions or events, the method comprising:
a server receiving via a network an electronic submission containing data for a capital market transaction or event requiring one or more of review and approval by a market entity, the data according to a predetermined structure, the server storing the data in a database;
evaluating the data contained in the electronic submission against a plurality of failure conditions, the plurality of failure conditions including at least one scalar failure condition, the at least one scalar failure condition identifying data that is to conform to an inequation for the scalar failure condition to be met;
processing the electronic submission upon completion of the evaluation when each failure condition of the plurality of failure conditions is not met;
upon successfully processing the electronic submission, updating the database to indicate that the submission has been successfully processed; and
when one or more failure conditions of the plurality of failure conditions is met, then updating the database to indicate that the data requires further analysis.

2. The method of claim 1, further comprising updating the at least one scalar failure condition based on one or more of:
a rate of successful processing of electronic submissions based on evaluation of the plurality of failure conditions; and
outcomes of electronic submissions based on the further analysis;
so as to control a rate of submissions that meet none of the failure conditions and control a rate of submissions requiring further analysis.

3. The method of claim 2, wherein the at least one scalar failure condition is updated based on a rate of successful approval of electronic submissions, so as to increase a rate of submissions that meet none of the failure conditions and decrease a rate of submissions requiring further analysis.

4. The method of claim 3, wherein the plurality of failure conditions further comprises at least one static failure condition, the at least one static failure condition identifying a data element of the data that is to be present or absent for the static failure condition to be met.

5. The method of claim 4, further comprising updating the at least one static failure condition based on one or more of:
a rate of successful processing for electronic submissions based on evaluation of the plurality of failure conditions; and
outcomes of electronic submissions based on the further analysis;
so as to control a rate of submissions that meet none of the failure conditions and control a rate of submissions requiring further analysis.

6. The method of claim 5, wherein the at least one static failure condition is updated based on a rate of successful approval of electronic submissions, so as to increase a rate of submissions that meet none of the failure conditions and decrease a rate of submissions requiring further analysis.

7. The method of claim 6, further comprising evaluating the inequation of the at least one scalar failure condition by comparing the data to a configurable value.

8. The method of claim 7, further comprising:
the server receiving data for the at least one scalar failure condition from a remote server via the network, the data for the at least one scalar failure condition being used to obtain a calculated value; and
evaluating the inequation of the at least one scalar failure condition by comparing the calculated value to a configurable value.

9. The method of claim 8, further comprising the server transmitting via the network an electronic alert to an analyst terminal upon updating the database to indicate that the data requires further analysis.

10. The method of claim 9, wherein the data of the electronic submission is representative of a private placement.

11. The method of claim 6, wherein the at least one static failure condition comprises an indication of a control person.

12. The method of claim 11, wherein the at least one static failure condition comprises an indication of a predetermined specific type of security.

13. The method of any claim 12, wherein the at least one static failure condition comprises presence of an additional open electronic submission associated with an entity submitting the electronic submission.

14. The method of claim 13, wherein the at least one static failure condition comprises presence of the data element in a compliance and disclosure database.

15. The method of claim 14, wherein the at least one scalar failure condition comprises an indication of an excessive placement amount to one or more insiders.

16. The method of claim 15, wherein the at least one scalar failure condition comprises an indication of an excessive placement amount to any combination of one or more insiders, one or more large holders, and one or more registered market professionals.

17. The method of claim 16, wherein the at least one scalar failure condition comprises an indication of an excessive placement amount relative to issued and outstanding securities.

18. The method of claim 17, wherein the at least one scalar failure condition comprises an indication of a price spike.

19. The method of claim 18, further comprising sending a notification indicative of the one or more of review and approval to a submitter terminal at which the electronic submission originates.

20. The method of claim 19, further comprising cross-referencing the data of the electronic submission with data present in at least one other existing data source remote from the database to validate the electronic submission.

21. The method of claim 20, further comprising cross-referencing the data of the electronic submission with data present in at least one other existing data source remote from the database as part of evaluating the data contained in the electronic submission against the plurality of failure conditions.

22. The method of claim 20, further comprising generating a review package including data from the electronic submission, any met failure conditions, and associated data obtained from at least one other existing data source remote from the database, and presenting the review package to an analyst terminal for the further review.

23. The method of claim 22, further comprising the server operating as a trusted identity provider for claims-based authentication of a submitter terminal at which the electronic submission originates.

24. A system for processing data pertaining to capital market transactions or events, the system comprising:
a network interface configured to receive data of an electronic submission from a submitter terminal over a network, the electronic submission pertaining to a capital market transaction or event requiring one or more of review and approval by a market entity;
a validation engine coupled to the network interface, the validation engine configured to issue a prompt to the submitter terminal for data that fails validation;
a database for storing the data of the electronic submission; and
a review and approval engine coupled to the network interface, the review and approval engine configured to evaluate the data contained in the electronic submission against a plurality of failure conditions, the plurality of failure conditions including at least one scalar failure condition, the at least one scalar failure condition identifying data that is to conform to an inequation for the scalar failure condition to be met;
the review and approval engine further configured to process the electronic submission upon completion of the evaluation when each failure condition of the plurality of failure conditions is not met;
the review and approval engine further configured to update the database to indicate that the submission has been successfully processed upon successfully processing the electronic submission; and
the review and approval engine further configured to update the database to indicate that the data requires further analysis when one or more failure conditions of the plurality of failure conditions is met.

25. The system of claim 24, wherein the review and approval engine is further configured to update the at least one scalar failure condition based on one or more of:
a rate of successful processing of electronic submissions based on evaluation of the plurality of failure conditions; and
outcomes of electronic submissions based on the further analysis;
so as to control a rate of submissions that meet none of the failure conditions and control a rate of submissions requiring further analysis.

26. The system of claim 25, wherein the at least one scalar failure condition is updated based on a rate of successful approval of electronic submissions, so as to increase a rate of submissions that meet none of the failure conditions and decrease a rate of submissions requiring further analysis.

27. The system of claim 26, wherein the plurality of failure conditions further comprises at least one static failure condition, the at least one static failure condition identifying a data element of the data that is to be present or absent for the static failure condition to be met.

28. The system of claim 27, wherein the review and approval engine is further configured to update the at least one static failure condition based on one or more of:
a rate of successful processing for electronic submissions based on evaluation of the plurality of failure conditions; and
outcomes of electronic submissions based on the further analysis;
so as to control a rate of submissions that meet none of the failure conditions and control a rate of submissions requiring further analysis.

29. The system of claim 28, wherein the at least one static failure condition is updated based on a rate of successful approval of electronic submissions, so as to increase a rate of submissions that meet none of the failure conditions and decrease a rate of submissions requiring further analysis.

30. The system of claim 29, wherein the review and approval engine is further configured to evaluate the inequation of the at least one scalar failure condition by comparing the data to a configurable value.

31. The system of claim 30, wherein the network interface is further configured to receive data for the at least one scalar failure condition from a remote server via the network, the data for the at least one scalar failure condition being used to obtain a calculated value, and wherein the review and approval engine is further configured to evaluate the inequation of the at least one scalar failure condition by comparing the calculated value to a configurable value.

32. The system of claim 31, further comprising a messaging engine configured to send an electronic alert to an analyst terminal upon update of the database to indicate that the data requires further analysis.

33. The system of claim 32, wherein the data of the electronic submission is representative of a private placement.

34. The system of claim 29, wherein the at least one static failure condition comprises an indication of a control person.

35. The system of claim 34, wherein the at least one static failure condition comprises an indication of a predetermined specific type of security.

36. The system of claim 35, wherein the at least one static failure condition comprises presence of an additional open electronic submission associated with an entity submitting the electronic submission.

37. The system of claim 36, wherein the at least one static failure condition comprises presence of the data element in a compliance and disclosure database.

38. The system of claim 27, wherein the at least one scalar failure condition comprises an indication of an excessive placement amount to one or more insiders.

39. The system of claim 28, wherein the at least one scalar failure condition comprises an indication of an excessive placement amount to any combination of one or more insiders, one or more large holders, and one or more registered market professionals.

40. The system of claim 39, wherein the at least one scalar failure condition comprises an indication of an excessive placement amount relative to issued and outstanding securities.

41. The system of claim 40, wherein the at least one scalar failure condition comprises an indication of a price spike.

42. The system of claim 41, further comprising a messaging engine configured to send a notification indicative of the one or more of review and approval to a submitter terminal at which the electronic submission originates.

43. The system of claim 42, wherein the review and approval engine is further configured to cross-reference the data of the electronic submission with data present in at least one other existing data source remote from the database to validate the electronic submission.

44. The system of claim 43, wherein the review and approval engine is further configured to cross-reference the data of the electronic submission with data present in at least one other existing data source remote from the database as part of evaluating the data contained in the electronic submission against the plurality of failure conditions.

45. The system of claim 44, wherein the review and approval engine is further configured to generate a review package including data from the electronic submission, any met failure conditions, and associated data obtained from at least one other existing data source remote from the database, and present the review package to an analyst terminal for the further review.

46. The system of claim 45, further comprising accounts logic configured to operate a trusted identity provider for claims-based authentication of a submitter terminal at which the electronic submission originates.
